(19) United States
(12) Patent Application Publication
(10) Pub. No.: US 2025/0245515 A1
(43) Pub. Date: Jul. 31, 2025

(54) GUIDED EXPLORATION METHOD FOR REINFORCEMENT LEARNING TRAINING

(71) Applicant: Dell Products L.P., Round Rock, TX (US)

(72) Inventors: Claudio Romero, Rio de Janeiro (BR); Eduardo Vera Sousa, Niterói (BR); Vinicius Michel Gottin, Rio de Janeiro (BR)

(21) Appl. No.: 18/425,358

(22) Filed: Jan. 29, 2024

(51) Int. Cl. G06N 3/092

(52) U.S. Cl. CPC G06N 3/092

(57) ABSTRACT

Reinforcement learning training using guided exploration. A reinforcement learning agent is trained by bootstrapping an existing heuristic. The training selects an initial balance between exploitation, exploration and guided exploration and executes a number of training steps. The remaining steps are performed by iteratively adjusting a balance between exploration, exploitation, and guided exploration. The trained reinforcement agent has improved generality compared to the existing heuristic and incurs less cost for online execution.

### FIELD OF THE INVENTION

Embodiments of the present invention generally relate to reinforcement learning. More particularly, at least some embodiments of the invention relate to systems, hardware, software, computer-readable media, and methods for reinforcement learning training using guided exploration.

### BACKGROUND

Reinforcement learning has been used in a wide variety of applications, including robotics, and games, where it is not possible to provide labels, or in complex and dynamic environments. Reinforcement learning (RL) is a type of machine learning (ML) in which an agent interacts with an environment, also referred to as a state space, through a set of actions, also referred to as an action space, with an objective of maximizing a reward. The agent learns how to solve a problem through experience or by performing actions. The experience is acquired during training where the agent may execute each action multiple times for different states of the environment.

The training process for reinforcement learning agents may include exploration and exploitation. In exploration, the agent randomly chooses an action. The model experiences the effectiveness of the action given the current state of the environment. Stated differently, there is a reward associated with performing the action in that environment. In exploitation, the agent selects the best action for the current environment based on past experiences or past learning. The agent selects the action with the highest reward for the current environment that was executed previously.

During the training process, exploration can improve the generalization of the agent being trained and exploitation can improve the accuracy of the agent being trained.

Reinforcement learning is a machine learning approach that deals with sequential decision-making. The reinforcement learning problem can be formalized as an agent that has to make decisions in an environment to optimize a given notion of cumulative rewards, where the reinforcement learning agent does not require complete knowledge or control of the environment. The agent only needs to be able to interact with the environment and collect information.

The reinforcement learning is often formulated as a Markov Decision Process (MDP) problem, where an agent interacts with its environment as follows: the agent starts, in a given state s₀∈S within its environment, by gathering an initial observation w₀∈Ω. At each time step t, the agent performs an action aₜ∈A and there are three consequences: (i) the agent obtains a reward rₜ∈R, (ii) the state sₜ transitions to sₜ₊₁∈S, and (iii) the agent obtains an observation wₜ₊₁∈Ω. The agent may be any entity capable of perceiving the state of the environment, performing actions, and receiving feedback in the form of rewards.

The Q-learning algorithm is well-known and is used to solve reinforcement learning problems, where the objective is to iteratively learn the optimal Q-value function using the Bellman Optimality Equation. To do this, all Q values are stored in a table that is updated at each step according to the following equation:

$${Q}_{t + 1} ( {s}_{t} , {a}_{c} ) ← ( 1 - α ) {Q}_{t} ( {s}_{t} , {a}_{t} ) + α [ r ( {s}_{t} , {a}_{t} ) + γ {max}_{a} {Q}_{t} ( {s}_{t} , {a}_{t} ) ] ,$$

where α is a learning rate (a hyperparameter that controls convergence), and γ is a discount factor that weights the importance of future rewards. During action selections, it is useful to select actions in a manner than balances the exploration and exploitation aspects of training. An appropriate balance prevents the agent from being pressured into local maxima or taking suboptimal actions.

The difficulty in balancing actions selected according to exploration principles and actions selected according to exploitation principles is an existing dilemma.

For example, a conventional Q-learning algorithm that illustrates the exploration and exploitation dilemma is as follows:
1. Initialize Q(s, a)
2. Observer the current state sₜ
3. do forever (stop criterium):
   a. select an action aₜ and execute it in sₜ (Exploration vs. Exploitation dilemma)
   b. receive immediate reward r(sₜ, aₜ)
   c. observe the new state sₜ₊₁
   d. update Q(s, a) as follows: Qₜ₊₁(sₜ, aₜ)←(1−α)Qₜ(sₜ, aₜ)+α[r(sₜ, aₜ)+γ maxₐQₜ(sₜ, aₜ)]
   e. the next state is now the current state sₜ←sₜ₊₁

Other algorithms, in addition to Q-learning, include A2C (Advantage Actor-Critic), and PPO (Proximal Policy Optimization). Each one these algorithms has advantages and disadvantages, but the choice of algorithm may depend on the specific reinforcement learning task and the characteristics of the environment in which the agent is operating.

As previously stated, the exploration-exploitation dilemma is a fundamental challenge in reinforcement learning. Exploration relates to obtaining information of the environment based on randomly selected actions, while exploitation relates to selecting actions to maximize the expected return given the current knowledge.

As an agent accumulates knowledge or learns about its environment, the agent needs to deal with a trade-off between learning more about its environment (exploration) or pursuing what seems to be the most promising strategy with the experience gathered so far (exploitation).

A simple method for balancing exploitation and exploitation is an ε-greedy method. This method behaves greedily most of the time. Every now and then, with a small probability, the method randomly selects an action from among a set of all actions. The purpose of exploration is to gather more information on the part of the search tree or action space where few simulations have been performed (i.e., where the expected value has a high variance). On the other hand, the purpose of exploitation is to refine the expected value of the most promising actions. The agent needs to exploit what has already experienced or learned in order to obtain a reward, but the agent also must explore in order to gather new information.

The ε-greedy method may be expressed as follows:

$$ε - greedy : {a}_{t} = \{ \begin{matrix}{a}_{t}^{*} with probability 1 - ε & exploitation \\ random action with probability ε & exploration\end{matrix} .$$

In this example, a high ε value results in more exploration and a lower ε value results in more exploitation. However, the value of ε can be static or dynamic. An adaptive approach to the E-greedy method involves changing the value of ε over time, for example by linear or exponential decay, where ε is initially set to a high value. This encourages intense exploration initially. Over time, however, this method encourages more exploitation than exploration.

However, training a reinforcement learning agent using the E-greedy method is very expensive. For example, in the context of a workload placement problem, the E-greedy method requires the actual execution of each workload in multiple different scenarios during exploration and exploitation.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of a reinforcement learning agent configured to place workloads in a system that includes computing resources;

FIG. 2 discloses aspects a method for training a reinforcement learning agent that includes guided exploration;

FIG. 3 discloses aspects of guided exploration;

FIG. 4 discloses aspects of a preprocessing stage of training a reinforcement learning agent;

FIG. 5 discloses aspects of an online phase of training a reinforcement learning agent;

FIG. 6A discloses aspects of a method for making a decision at a step of a dynamic stage of training a reinforcement learning agent;

FIG. 6B discloses aspects of a dynamic stage of a method for training a reinforcement learning agent;

FIG. 7 discloses a representation of experimental action sampling strategies;

FIG. 8A discloses aspects of comparative results between embodiments of the invention and conventional approaches to training a reinforcement learning agents;

FIG. 8B aspects of cumulative rewards in the context of training a reinforcement learning agent; and

FIG. 9 discloses aspects of a computing device, system, or entity.

### DETAILED DESCRIPTION OF SOME EXAMPLE EMBODIMENTS

Embodiments of the present invention generally relate to reinforcement learning and to training reinforcement learning models. More particularly, at least some embodiments of the invention relate to systems, hardware, software, computer-readable media, and methods for training a reinforcement learning agent using guided exploration. Guided exploration leverages an existing model, such as a heuristic, to reduce training costs while balancing the need for exploration and the generalization that exploration provides the reinforcement learning agent.

Embodiments of the invention thus relate to reinforcement learning, training reinforcement learning models (agents), and using reinforcement learning for optimization purposes. Embodiments of the invention are discussed in the context of a workload placement problem, but may be adapted to problems in which reinforcement learning may be used.

In one example, an optimizer is assumed to be available to solve a workload placement problem. The optimizer, however, typically incurs a high cost and is not suitable for making data placement decisions, particularly when the decision is time sensitive. In these scenarios, a heuristic (a heuristic model) is often developed and used. The heuristic achieves lower quality results (non-optimal) at lower cost. However, heuristics may not be general enough and may not be able to handle the varied range of cases in the actual domain.

This problem is relevant to data placement problems because the heuristic may be fine-tuned to certain values or short ranges of values of dynamic properties of the domain. In the example of the data placement problem, these properties correspond to the characteristics of the computational environment and to those of the workloads as well.

Advantageously, training a reinforcement learning agent may represent a trade-off. The reinforcement learning agent may be able to achieve results that are comparable to or better than the results provided the heuristic. For example, the reinforcement learning agent may be trained to account for more generalization of the domain. Training the reinforcement learning agent, however, is very expensive, which raises the problem of bootstrapping the reinforcement learning model to both reduce costs and ensure a proper level of generalization.

Embodiments of the invention may leverage an existing model/algorithm/heuristics to, in its simplest form, bootstrap the training of the reinforcement learning model, and in its complete (but costlier) form, to guide the training of the reinforcement learning agent so that reinforcement learning agent can better approximate the underlying optimization problem.

Embodiments of the invention more specifically relate to a novel form of exploration referred to as guided exploration. Embodiments of the invention may be used alone or in conjunction with exploration and exploitation processes typically used in training reinforcement learning agents.

In guided exploration, the action selected by an existing model (e.g., a heuristic) is determined and that action is used to train the reinforcement learning agent. Guided exploration can be used when bootstrapping the training process, and/or used in conjunction with the typical exploration and exploitation processes to try and obtain a model that better fits the underlying optimization problem and/or that generalizes to more states/inputs. Embodiments of the invention further relate to adaptively selecting how much to use exploration, exploitation, and/or guided exploration. In some examples, a method for performing guided exploration may include aspects of exploration and exploitation.

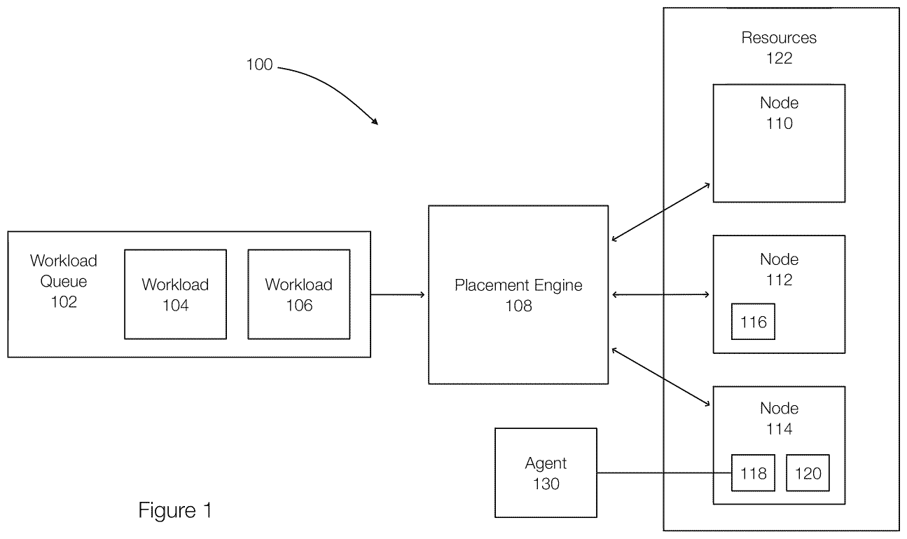

FIG. 1 discloses aspects of reinforcement learning based workload placement in a computing environment. A system 100 (e.g., a datacenter or other computing environment) may include resources 122. The resources 122 may include nodes, which are represented by the nodes 110, 112, and 114. The nodes 110, 112, and 114 may each include a computing device or system with processors, memory, network hardware, and the like. The nodes 110, 112, and 114 may include physical machines, virtual machines, containers, and the like. Workloads are typically assigned to computers, containers, or virtual machines operating on the nodes 110, 112, and 114.

The resources 122 of the system 100 may be used to perform jobs or workloads. In other words, the system 100 allocates the resources 122 to perform the workloads. Allocating a resource may include placing a workload at a node (e.g., at a virtual machine) and/or migrating a workload from one node to another node or from one virtual machine to another virtual machine.

The following discussion assumes that workloads are performed by virtual machines and that each of the nodes 110, 112, and 114 may support one or more virtual machines. Further, each virtual machine may perform or execute one or more workloads.

The system 100 may include or have access to a workload queue 102 that stores workloads, represented by the workloads 104 and 106. When a user submits a workload, the workload may be stored in the workload queue 102 and then placed in the resources 122.

The system 100 may also include a placement engine 108, which may also operate on a node or server. The placement engine 108 may include a machine learning model, neural network, reinforcement learning model, or the like. In one embodiment, the placement engine 108 may include a reinforcement learning model configured to generate placement recommendations or actions for workloads executing in the resources 122. The placement recommendations may have different forms. When a placement is performed, the agent performs the placement (or action) that is associated with the highest reward. FIG. 1 illustrates operation of a placement engine, which was trained using guided exploration.

FIG. 1 illustrates that a workload 116 has been placed at the node 112 and that workloads 118 and 120 have been placed at the node 114. More specifically, the workload 116 may be performed by a virtual machine instantiated on the node 112 and the workloads 118 and 120 may be performed by one or more virtual machines instantiated on the node 114. These workloads 116, 118, and 120 were placed, in one example, by an agent based on recommendations of the placement engine 108. The agent 130 and placement engine 108 represent the reinforcement learning model in one example.

The placement engine 108 may evaluate the state of the resources 122 as well as an actual reward associated with the execution of the workloads 116, 118, and 120 to generate new placement recommendations. This may result in the migration of one or more of the workloads 116, 118, and 120 to different virtual machines or to a different portion of the resources 122.

The placement engine 108, once trained, thus makes placement decisions or placement recommendations. Placement decisions or recommendations may include placing a new workload at a node or a virtual machine, moving or migrating a workload from a current node or virtual machine to a different node or virtual machine, and keeping a workload at the same node or virtual machine.

Aspects of placing workloads, such as illustrated in FIG. 1, are described in U.S. Ser. No. 17/811,693 filed Jul. 11, 2022 and entitled SWARM MULTI-AGENT REINFORCEMENT LEARNING-BASED PIPELINE FOR WORKLOAD PLACEMENT, which application is incorporated by reference in its entirety.

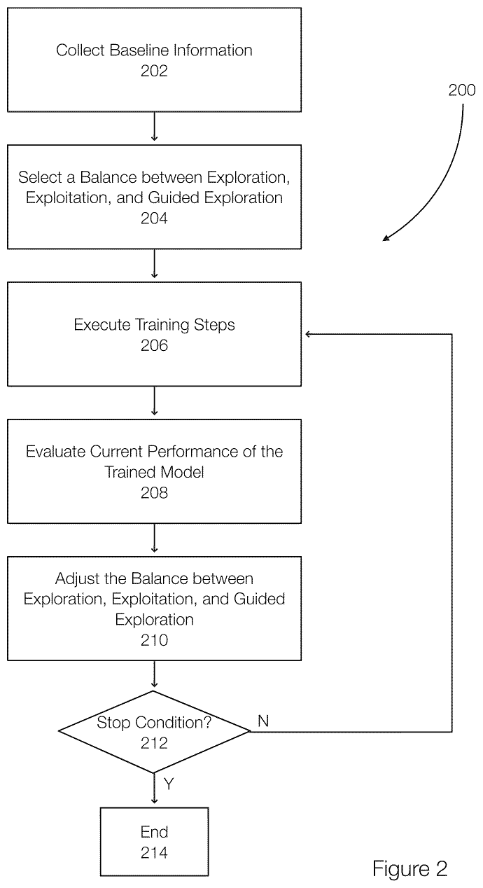

FIG. 2 discloses aspects of an example method for training a reinforcement learning model (e.g., agent). The example method 200 includes training using guided exploration. The method 200 includes collecting 202 baseline information. More specifically collecting 202 baseline information includes collecting information about the underlying optimization problem by solving the optimization problem for multiple benchmark states. Results provided by a preexisting heuristic (or model) over the same benchmarks may be obtained. This allows information about how well the existing heuristic generalizes to the domain, for example by computing a proportion of benchmark cases for which the performance of the existing heuristic is substantially lower that a performance of an optimizer.

During training, the method 200 then selects 204 a balance between exploration, exploitation and guided exploration. This choice may depend on the assessment performed when collecting 202 the baseline information. After an initial balance has been selected 204, a predetermined number of training steps are executed 206. The current performance of the agent being trained is evaluated 208 in the context of the existing heuristic and the baseline solutions previously determined.

The evaluation 208 of the agent's performance is used to readjust 210 the balance between exploration, exploitation, and guided exploration. If a stop condition is satisfied (Y at 212), the method 200 ends. If the stop condition is not achieved (N at 212), the method returns to executing 206 a predetermined number of steps. Thus, the method 200 continues until a stop condition is achieved (Y at 212). An example stop condition may be that the performance is within a threshold distance of a performance of an optimizer, allowed cost is spent, or allocated resources have been consumed.

In one example of the method 200, a budget is tracked, which may be related to availability of resources. The budget is spent as the training operation progresses. The balance or choice of exploration and guided exploration may be constrained to a predetermined budget. More specifically, embodiments of the invention are expected to converge towards exploitation as training nears completion. Thus, the budget may be an example of a stop condition.

Embodiments of the invention perform guided exploration through which a reinforcement learning agent is trained based on an existing heuristic to reduce training costs and/or to balance the need for exploration and the generalization that exploration provides in training the reinforcement learning agent. Embodiments of the invention, by way of example, are discussed in the context of a workload or task that may be performed iteratively and in an online manner (e.g., cloud-based workload placement).

In one example, embodiments of the invention assume that an optimizer configured to yield optimal decisions with response to a well-defined utility function is available. The execution of the optimizer, however, is not practical for use in an online manner consistently due in part to cost (e.g., in terms of time, resources, and or economics).

In addition, the availability of a heuristic is also assumed. The heuristic is defined using domain knowledge such that good-enough solutions are obtained with diminished computational cost. In other words, the heuristic is less expensive than the optimizer, but presents challenges that are often related to the heuristic's lack of generalization. The heuristic may not be capable of handling certain scenarios and may fall back to the full optimizer. This is undesirable as it would be advantageous to avoid using the optimizer at least in an online context.

Embodiments of the invention relate to training a reinforcement learning agent to perform the task (e.g., workload placement) in a manner that leverages the existing heuristic where possible and keeps computational costs comparatively low and upfront and in an offline context, which is less expensive than employing the optimizer in an online fashion.

In one example, training the reinforcement learning agent includes a dynamic action sampling strategy. This may include dynamically determining how much the agent would likely benefit from further exploration while converging towards a full-exploitation strategy at the end of the training process or as the training operation nears conclusion.

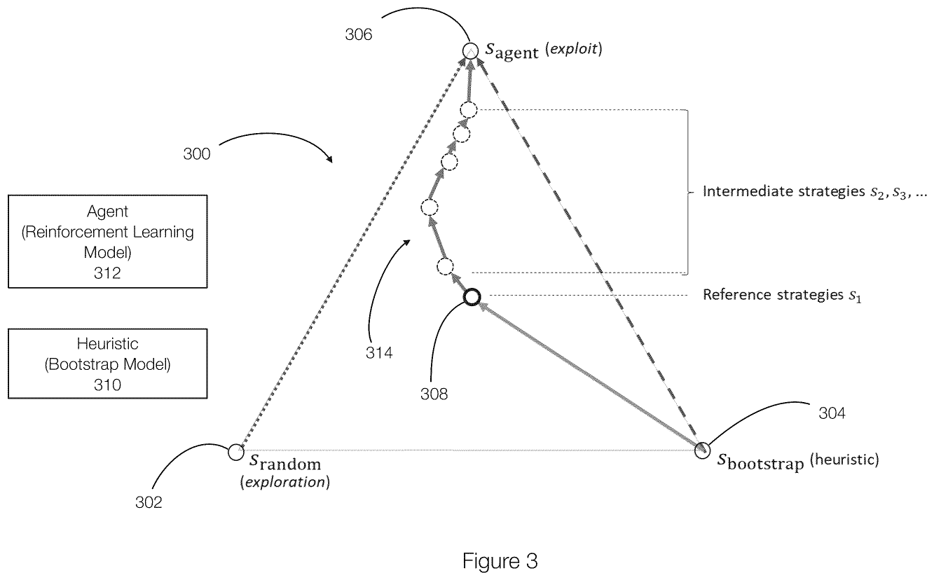

FIG. 3 discloses aspects of training a reinforcement learning agent using guided exploration. Training a reinforcement learning agent may include exercising or executing the agent in the domain (performing actions) such that its experiences change its internal beliefs about the appropriate or most likely best actions at each state. A training operation allows the reinforcement learning agent to learn based on observations of the results, and the rewards of the selected actions. This has both immediate and long term effects on the agent

FIG. 3 illustrates a space 300 of strategies for sampling actions in reinforcement learning. Each point in the space 300 determines an action-sampling strategy s. FIG. 3 relates to a model being trained (reinforcement learning model or agent 312) and a heuristic 310 (e.g., a bootstrapped model).

In FIG. 3, the s_{random} point 302 indicates that the agent 312 will determine or select 100% of its actions purely by chance or randomly.

The s_{bootstrap} point 304 indicates means the agent 312 will determine or select 100% of its actions in accordance with the external model (e.g., the heuristic).

The s_{agent} point 306 indicates that the agent 312 will determine or select 100% of its actions according to its own current beliefs or learning (i.e., the actions that result in the best rewards as far as the agent 312 can tell).

Any other point in the space 300 indicates that the actions taken by the agent 312 will be drawn or selected according to these strategies: s_{random}, s_{bootstrap}, and s_{agent}. For example, the reference point s₁ 308 is or equals a barycenter of the triangle action space 300. At this point 308 s₁, the actions selected or performed by the agent 312 will be drawn in equal proportion using a random strategy (exploration), from the heuristic (existing model) and/or by the agent itself (exploitation). The intermediate strategies 314 (e.g., s₁, s₂, . . . ) represent aspects of guided exploration in selecting actions during a training operation.

FIG. 3 also illustrates a traditional approach to reinforcement learning. In traditional explore/exploit reinforcement training, the agent starts taking purely random actions, which constitutes exploration of the state space 300. Then, the agents increasingly starts taking the ‘best’ actions according to its own current beliefs (i.e., according to the model being trained). Conversely, in traditional bootstrapping, the model or agent being trained initially “imitates” an externally provided reference model (the heuristic, in one example), and progressively starts to take actions according to its own current beliefs or learning.

Traditional explore/exploit learning does not require an external model or heuristic. Traditional exploration provides the model with greater generality, as the model learns to traverse the space-state randomly. The downside is that this is expensive/wasteful. For example, the agent may spend significant time learning about how to deal with parts of the state-space that are only achieved by objectively bad/sub-optimal sequences of actions.

Traditional bootstrap may be used when an external heuristic is available. However, traditional bootstrapping may be costly. Even if the heuristic 310 is less expensive than the optimizer, the heuristic 310 may still incur a significant cost. Further, the heuristic 310 may not explore important and relevant parts of the state-space for which the external heuristic 310 does not account.

Embodiments of the invention thus relate to a training strategy that leverages the exploitation provided by the heuristic 310 or other existing model and the generality provided by exploration. Embodiments of the invention dynamically determine an action-sampling strategy in bootstrapped reinforcement learning training that balances the computational costs of training and the generality of the trained agent.

In one example, training an agent, such as the agent 312, may include a preprocessing stage and an online stage. The preprocessing stage is configured to evaluate the generality of the available heuristic with respect to the optimal solutions for a benchmark set of cases. This generality is used to determine a first reference strategy s₁ for training the reinforcement learning agent 312, such that the more the heuristic generalizes, the closer the reference strategy is to the s_{agent} strategy (exploit).

The online stage may occur concurrently to the training epochs performed when training the reinforcement learning agent. The action-sampling strategy for training the agent may be performed in two stages: a startup stage and a dynamic stage.

In the startup stage, the strategy for selecting actions progressively changes from relying solely on the heuristic 310 towards the reference strategy s₁ at point 308 in this example. In a dynamic stage, the generality of the agent 312 is periodically assessed versus the heuristic 310 (and/or the optimizer) and the exploration aspects of the action sampling strategy is adjusted. The strategy is also progressed or adapted towards the exploit strategy represented by the point 306 based on an assessment of available resources, cost, and/or time.

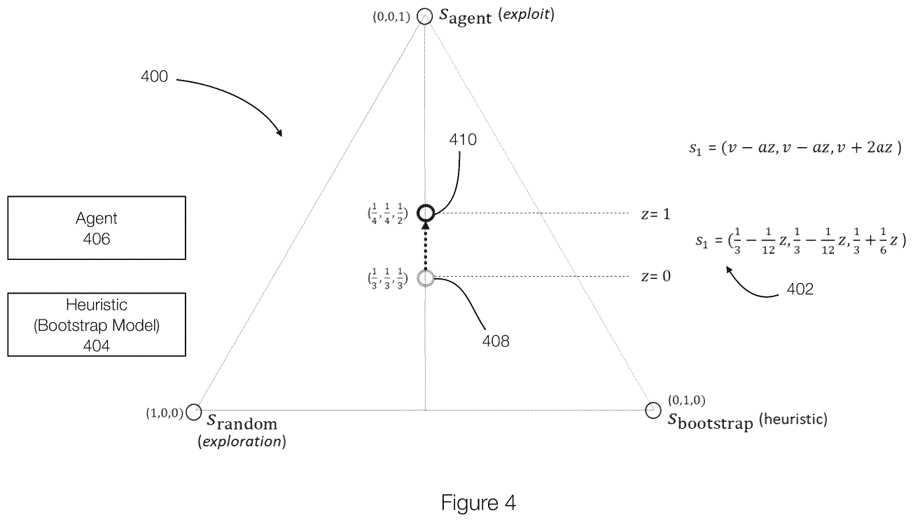

FIG. 4 discloses aspects of the preprocessing stage of reinforcement learning training. In one example, the preprocessing stage is performed offline, which may allow for some costly processing. This offline processing is used to gather baseline information regarding a performance of an optimizer. This may be used as a guide for determining the generality of the heuristic and/or the reinforcement learning agent being trained.

Initially, a set of benchmark cases for the end-goal task are obtained. These can be obtained from previous instances of the task in a domain, or from any suitable database of past executions. Alternatively, if a procedure for generating synthetic new cases is available, a sufficient number of such cases can be generated.

The optimizer is executed for each case and an overall and/or individual performance assessment of the benchmark cases is obtained. The heuristic is applied to the same set of benchmark cases and performance of the heuristic is obtained. This allows the performance of the optimizer to be compared to the performance of the heuristic and obtain a proportion of cases for which the heuristic performs poorly. The definitions depend on the end-goal task and on the utility function, which may determine a quality of the results.

In the case of the workload placement task, the following cases are considered: (i) cases in which the quality of the optimal result r₀ is greater than the quality of the heuristic result rₕ by some predetermined threshold, and (ii) cases in which the heuristic is unable to yield a result and falls back to the optimizer.

The proportion of cases computed above or relative performance can be used as a reference score for how well the heuristic generalizes to the domain. As the heuristic is bootstrapped to the reinforcement learning agent, this score helps determine the evolution of the action sampling strategy during training.

FIG. 4 illustrates an initial strategy 402 s₁ adapted based on the generalization score of the heuristic 404. FIG. 4 illustrates how the reference strategy 402 s₁ is adapted depending on the generalization score z of the heuristic (e.g., the heuristic 404). The more generalizing the heuristic 404, the closer to the s_{agent} s₁ is placed for the online training stage.

In the general form, an initial point (v₀, v₁, v₂) and a variation a are defined. This variation is negatively applied to the s_{random} (v₀) and s_{bootstrap} (v₃) aspects, and positively applied to the s_{agent} (v₂) aspect of the action selection strategy. In one example, the reference point s₁ is most conservative. If the heuristic 404 generalized well, s₁ may be nudged to be more ‘greedy’ with respect to the agent 406 or with respect to s_{agent} (v₂). In one example, the score z is used a weight factor to increase the agent aspect (exploitation) of the initial reference strategy.

In the absence of any information (generalization score for the heuristic or heuristic 404), the reference point s₁ 402 is assumed to be the barycenter of the state space 400 in one example, which allows for an equivalent proportion of actions to be drawn from each of the three strategies (the heuristic, at random and the agent itself)—with v₀, v₁ and v₂ all equal to ⅓. In the example illustrated in FIG. 4, the variation a is defined to be 1/12 such that a maximum score z=1 changes the s_{agent} from ⅓ to ½ (with the random and bootstrap aspects decreased correspondingly) as illustrated by the point 410. In one example, the initial or reference point s₁ may be positioned between the point 408 and the point 410, depending on the value of z.

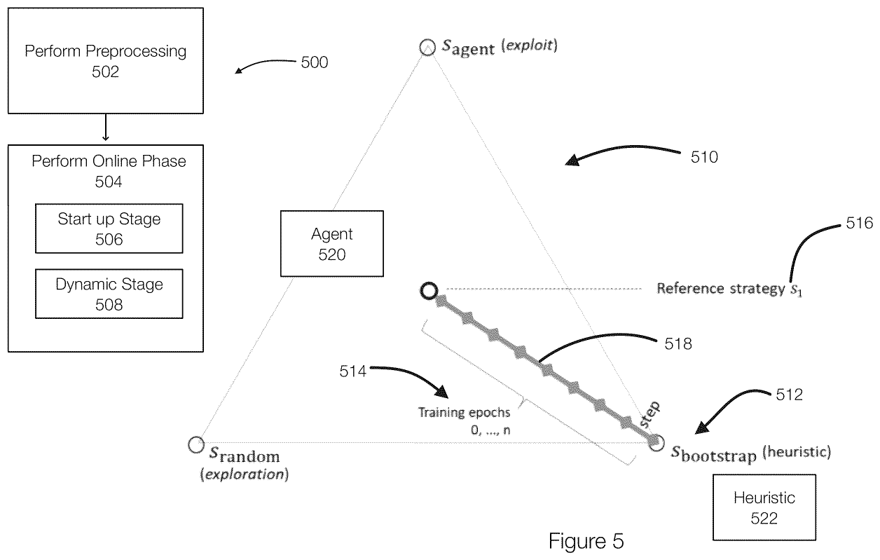

FIG. 5 discloses aspects of an online phase for training a reinforcement learning agent and aspects of a method for training the reinforcement learning agent. The method 500 includes performing 502 a preprocessing phase as illustrated in FIG. 4. After the preprocessing phase is completed, an online phase is performed 504. The online phase 504 includes a startup stage 506 and a dynamic stage 508. When performing 504 the online phase, the action-sampling reference strategy for training the reinforcement learning agent is adapted.

More specifically, the online phase begins with a startup stage 506. The startup stage 506 of training the reinforcement learning agent starts with a s_{bootstrap} action-sampling strategy. For training epochs 514, the agent 520 selects and performs actions and observes rewards according the heuristic 522. Thus, for the first or initial training epochs, the agent 520 takes the actions and observe the rewards as if the heuristic 522 were being used. For a set number of startup epochs, in one example, the agent 520 move towards the reference strategy s₁ 516 (determined when performing 502 preprocessing) in the action-sampling space 510, such that the agent 512 progressively adopts sampling strategies that draw more random actions and more actions according to its own current beliefs or learning.

In the example of FIG. 5, a ‘straight’ path 518 from the 512 s_{bootstrap} strategy to the reference strategy s₁ 516 is determined. In this nonlimiting example, a pseudocode for the startup stage 506 is as follows.

First, given a target number of startup epochs n, define a step as

$$\frac{1}{n}$$

the distance between s_{heuristic} and s₁ linearly in the action-sampling space 510.

Second, define the current action-sampling strategy for the first training epoch s as s_{bootstrap} or s_{heuristic}.

Third, for each epoch e in n, perform the training of the reinforcement learning agent 520 and update the current strategy s by a step towards the reference strategy s₁.

FIG. 5 illustrates an example path 514. However, embodiments of the invention may use other predetermined paths to the startup stage 506. For example, a fixed path that follows a parabola may be determined and used during the startup stage 506. It is noted that if the reference strategy is set to be an exploitation strategy where s₁=s_{agent}, the above embodiment of a linear interpolation between s_{bootstrap} and s₁ corresponds identically or substantially identically to the basic ‘bootstrapping’ approach.

Embodiments of the invention may be parametrized so that s₁=s_{bootstrap}, such that the startup stage is effectively skipped and the entire training of the reinforcement learning agent 520 takes place in the dynamic stage 508, as described below. Empirical testing, however, indicates that a general rule of “forcing” a skew towards randomness in the beginning of the training operation leads generally to good results.

After performing the startup stage 506, the remaining training epochs include an action-sampling strategy adapted by the dynamic stage 508. In the dynamic state 508, a target of maximum resource usage and/or time to complete the training may be considered or targeted. This target can be used to iteratively determine the step size for the adjustment of the current action sampling strategy. A “budget” (typically related to availability of resources) may be tracked that is spent as the training progresses. The choice of exploration or guided exploration may be constrained to a sufficient budget. Stated differently, the training is expected to converge towards the exploitation aspect as the training comes close to an end.

Briefly, FIG. 3 illustrates examples of intermediate strategies 314 s₂, s₃, . . . from s₁ to s_{agent}. These represent aspects of steps performed during the dynamic stage 508 of the method 500

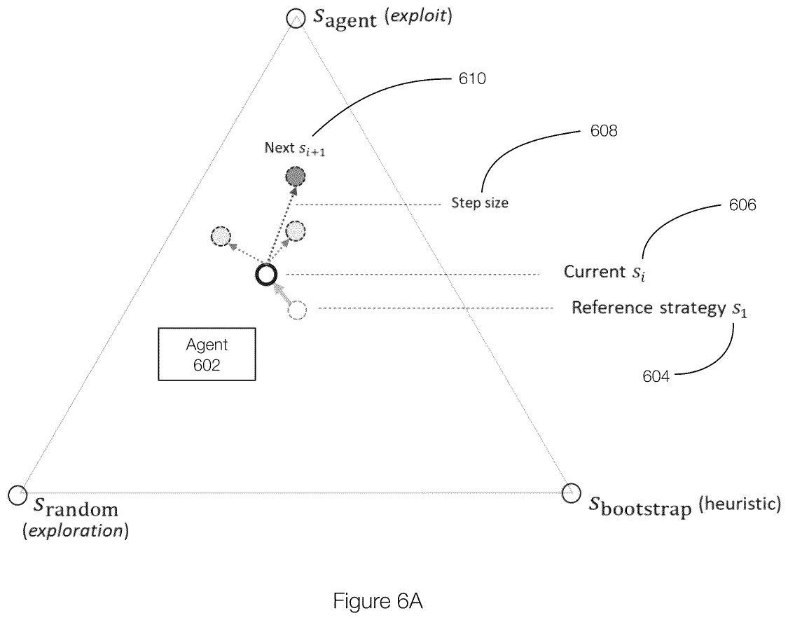

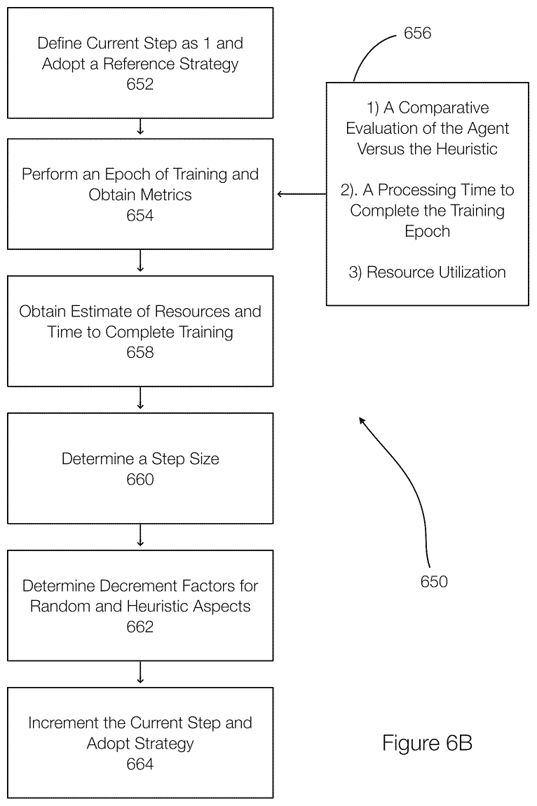

FIG. 6A discloses aspects of making a decision at step i in the dynamic stage 508. More specifically, FIG. 6A illustrates a current strategy sᵢ 606, which is one or more steps after the reference strategy s₁ 604. The path from s₁ to sᵢ is summarized in FIG. 6A.

After a training epoch adopting sᵢ, a next strategy 610 sᵢ₊₁ is defined by advancing generally towards s_{agent}. In one example, the proportionality of the influence of s_{random} and s_{bootstrap} is reduced in one example. The reduction in each of the latter aspects are pondered with a perceived quality of the agent versus the perceived quality of the heuristic at the current step.

FIG. 6B discloses aspects of a method for training a reinforcement agent in the dynamic stage. The method 650 includes defining 652 a current step i as 1 (e.g., s₁ and adopting a reference strategy. For example, the startup stage may train the agent up to the reference strategy. For the dynamic stage, the reference strategy is adopted at and referenced as step 1.

Next, an epoch of training is performed 654 and metrics are obtained. Example metrics 656 include (i) a comparative evaluation of the agent versus the heuristic, (ii) a processing time to complete the training epoch, and (iii) resource utilization.

Next, a current estimate of available resources and/or time to complete the training of the reinforcement agent is obtained 658. A step size 660 is determined 660 from the metrics (e.g., metrics (ii) and (iii)) and from the estimate of resources and or time needed to complete the training in 658. The step size determines the increment for the s_{agent} aspect in the step from sᵢ to sᵢ₊₁.

Factors (w₀, w₁) are then determined 662 for the random (s_{random}) and heuristic (s_{heuristic}) aspects of the strategy in moving from sᵢ to sᵢ₊₁. These factors are based on the metric (i) above such that w₀+w₁=y.

The method 650 thus changes the current strategy

$${s}_{i} = ( {v}_{0}^{i} , {v}_{1}^{i} , {v}_{1}^{i} )$$

$$to$$

$${s}_{i + 1} = ( {v}_{0}^{i} - {w}_{0} , {v}_{1}^{i} - {w}_{1} , {v}_{1}^{i} + y ) ; {w}_{0} + {w}_{1} = y .$$

The metrics may be domain-dependent and may be defined with respect to specific available resource metrics. In one example, embodiments of the invention may measure an execution time of a current epoch. Considering a desired time to finish the training, it may be possible to extrapolate that future epochs will take, on average, the same amount of time. More complex tracking and estimation mechanisms can be defined, including for resource utilization metrics.

If a boundary condition is present, such as when resources are estimated to be depleted or the training is determined to be over budget, a straightforward approach is to adopt the strategy s_{agent} for a final training epoch and complete the training of the reinforcement learning agent.

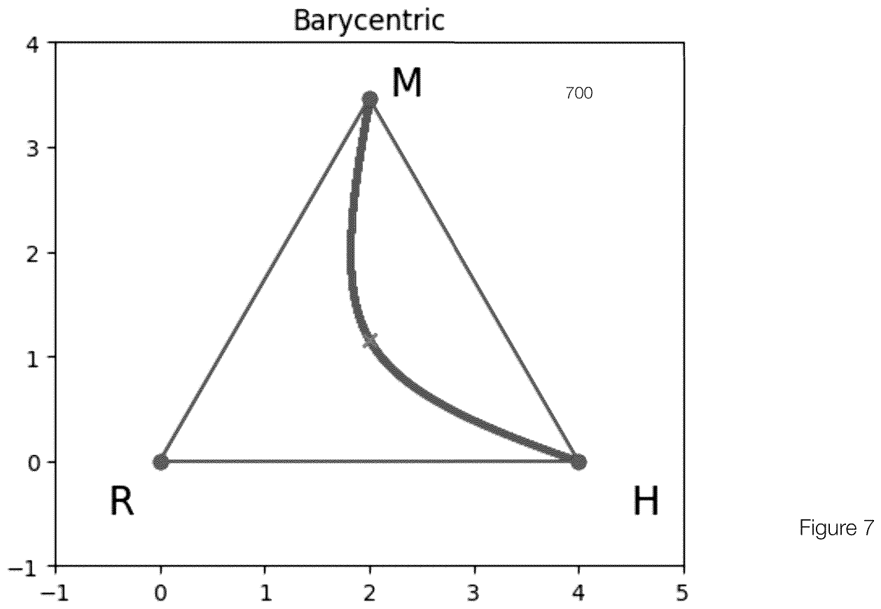

FIG. 7 illustrates a representation of experimental action sampling strategies. The graph 700 illustrates an experiment when the agent is forced to follow a ‘path’ of strategies that is predetermined. In other words, the monitoring and dynamic determination of the intermediate strategies is not orchestrated. The experiments illustrate that leveraging the heuristic as an example bootstrapping model can speed up the convergence of the reinforcement learning agent. These experiments further illustrate that using a bootstrap strategy and a random strategy yields better generalization that bootstrapping alone.

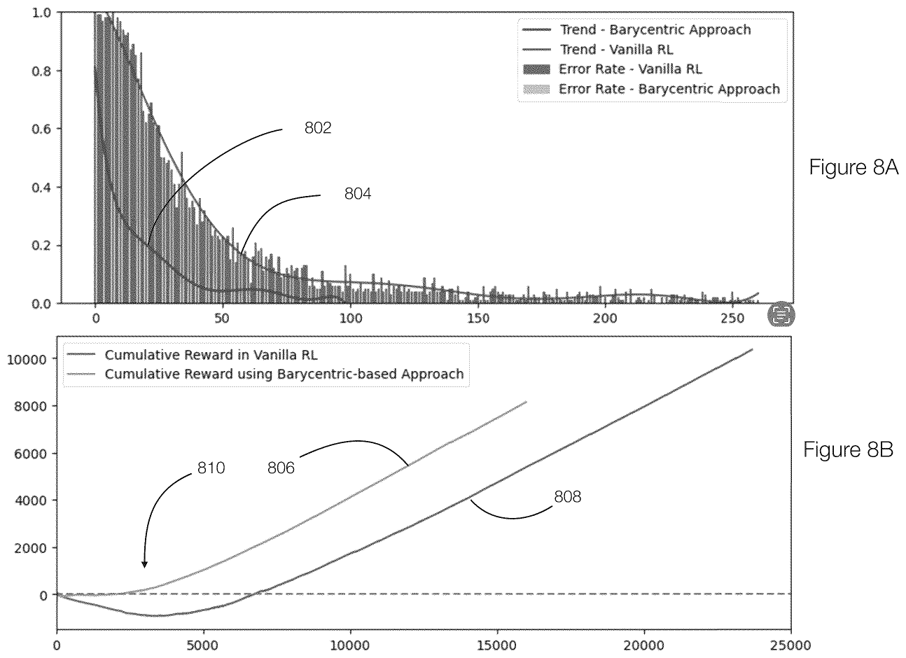

FIG. 8A discloses comparative results between embodiments of the invention and baseline approaches. For example, a barycentric approach 802 has an error rate that decreases faster compared to a baseline approach 804. FIG. 8A also illustrates that convergence is achieved more quickly in embodiments of the invention. In this experiment, convergence was achieved in about 100 epochs in embodiments of the invention instead of 250+ epochs using a baseline or vanilla approach.

FIG. 8B discloses aspects of cumulative approaches and illustrates cumulative rewards. The barycentric approach in accordance with embodiments of the invention has a cumulative reward 806 and the baseline approach has a cumulative reward 808. FIG. 8B illustrates that an agent trained in accordance with embodiments of the invention is more profitable under the reward aspect. The minimum values 810 of the curves in FIG. 8B show how much reward must be lost before the trainings start to gain. The zero crossing points illustrate that embodiments of the invention recover from losses more quickly compared to a baseline approach. Finally, the zero crossing points show that the training in accordance with embodiments of the invention recovers faster from the losses when compared to trainings using a baseline approach.

As apparent from this disclosure, an embodiment of the invention may possess various useful features and aspects, although no embodiment is required to possess any of such features or aspects. Embodiments of the invention may include or relate to migration operations, template operations, template creation operations, zero trust architecture related operations, migrating brownfield or greenfield systems to zero trust architectures, or the like or combinations thereof. Embodiments of the invention may relate to any operations related to migrating/replicating data in an energy aware manner.

Following are some further example embodiments of the invention. These are presented only by way of example and are not intended to limit the scope of the invention in any way.

Embodiment 1. A method comprising: performing a preprocessing stage of training a reinforcement learning agent being trained to perform a task in a computing system to determine a reference strategy based on a performance quality of a heuristic, and performing an online stage of training the reinforcement learning agent by dynamically adapting an action selection strategy for each training epoch.

Embodiment 2. The method of embodiment 1, wherein the performance quality is determined by comparing a generalization of an optimizer to a generality of the reinforcement learning agent.

Embodiment 3. The method of embodiment 1 and/or 2, further comprising performing a predetermined number of training epochs to move toward the selection strategy, wherein the predetermined number of training epochs select actions like the heuristic.

Embodiment 4. The method of embodiment 1, 2, and/or 3, further comprising adopting the reference strategy for a first step of the online stage.

Embodiment 5. The method of embodiment 1, 2, 3, and/or 4, further comprising performing an online training epoch and obtaining metrics.

Embodiment 6. The method of embodiment 1, 2, 3, 4, and/or 5, wherein the metrics include: a first metric including a comparative evaluation of the reinforcement learning agent and a heuristic, a second metric including a processing time to complete the training epoch; and a third metric including resource utilization.

Embodiment 7. The method of embodiment 1, 2, 3, 4, 5, and/or 6, further comprising determining a step size based on the second metric and the third metric, wherein the step size relates to an increment for a next exploitation aspect of a next action selection strategy used in a next training epoch.

Embodiment 8. The method of embodiment 1, 2, 3, 4, 5, 6, and/or 7, further comprising determining a next random aspect and a next heuristic aspect of the next training epoch.

Embodiment 9. The method of embodiment 1, 2, 3, 4, 5, 6, 7, and/or 8, further comprising changing the action strategy to a next action strategy based on the next exploitation aspect, the next random aspect, and the next heuristic aspect.

Embodiment 10. The method of embodiment 1, 2, 3, 4, 5, 6, 7, 8, and/or 9, wherein the next action selection strategy (sₙₑₓₜ) is based on sₙₑₓₜ=(v₁−az, v₂−az, v₃+2az), wherein a is a variation, z is a generalization score, and (v₁, v₂, v₃) corresponds to a current strategy, wherein v₁ relates to a random aspect of the action-selection strategy, v₂ relates to an exploitation aspect of the action-selection strategy, and v₃ relates to a heuristic aspect of the action-selection strategy.

Embodiment 11. The method of embodiment 1, 2, 3, 4, 5, 6, 7, 8, 9, and/or 10, further comprising finishing the training when a budget is consumed or resources are unavailable.

Embodiment 12. A system comprising hardware and/or software, operable to perform any of the operations, methods, or processes, or any portion of any of these, disclosed herein.

Embodiment 13. A non-transitory storage medium having stored therein instructions that are executable by one or more hardware processors to perform operations comprising the operations of any one or more of embodiments 1-11.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term client, module, component, engine, agent, service, or the like may refer to software objects or routines that execute on the computing system or may also refer to hardware depending on context. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments, which may be remote or on-prem, where one or more of a client, server, or other machine may reside and operate in a cloud environment.

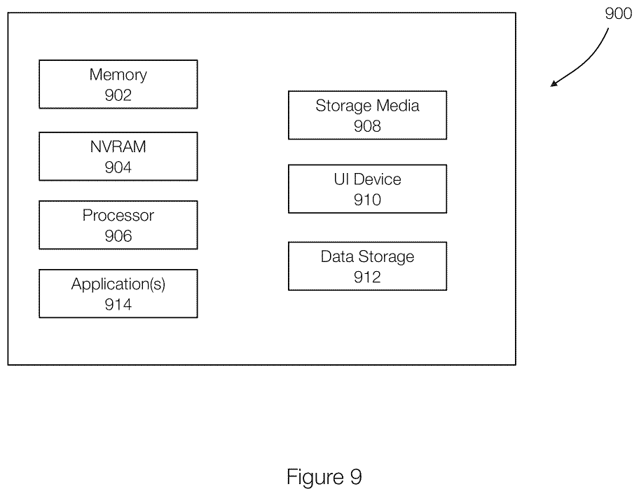

With reference briefly now to FIG. 9, any one or more of the entities disclosed, or implied, the Figures and/or elsewhere herein, may take the form of, or include, or be implemented on, or hosted by, a physical computing device, one example of which is denoted at 900. As well, where any of the aforementioned elements comprise or consist of a virtual machine (VM), that VM may constitute a virtualization of any combination of the physical components disclosed in FIG. 9.

In the example of FIG. 9, the physical computing device 900 includes a memory 902 which may include one, some, or all, of random access memory (RAM), non-volatile memory (NVM) 904 such as NVRAM for example, read-only memory (ROM), and persistent memory, one or more hardware processors 906, non-transitory storage media 908, UI device 910, and data storage 912. One or more of the memory components 902 of the physical computing device 900 may take the form of solid state device (SSD) storage. As well, one or more applications 914 may be provided that comprise instructions executable by one or more hardware processors 906 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The device 900 may also be representative of servers, clusters of servers, nodes, or the like. The computing resources represented by the device 900 may represent the computing resources of a cloud provider that can be allocated or used for energy aware compression operations.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
performing a preprocessing stage of training a reinforcement learning agent being trained to perform a task in a computing system to determine a reference strategy based on a performance quality of a heuristic; and
performing an online stage of training the reinforcement learning agent by dynamically adapting an action selection strategy for each training epoch.

2. The method of claim 1, wherein the performance quality is determined by comparing a generalization of an optimizer to a generality of the reinforcement learning agent.

3. The method of claim 1, further comprising performing a predetermined number of training epochs to move toward the selection strategy, wherein the predetermined number of training epochs select actions like the heuristic.

4. The method of claim 1, further comprising adopting the reference strategy for a first step of the online stage.

5. The method of claim 4, further comprising performing an online training epoch and obtaining metrics.

6. The method of claim 5, wherein the metrics include:
a first metric including a comparative evaluation of the reinforcement learning agent and a heuristic;
a second metric including a processing time to complete the training epoch; and
a third metric including resource utilization.

7. The method of claim 6, further comprising determining a step size based on the second metric and the third metric, wherein the step size relates to an increment for a next exploitation aspect of a next action selection strategy used in a next training epoch.

8. The method of claim 7, further comprising determining a next random aspect and a next heuristic aspect of the next training epoch.

9. The method of claim 8, further comprising changing the action strategy to a next action strategy based on the next exploitation aspect, the next random aspect, and the next heuristic aspect.

10. The method of claim 9, wherein the next action selection strategy (sₙₑₓₜ) is based on sₙₑₓₜ=(v₁−az, v₂−az, v₃+2az), wherein a is a variation, z is a generalization score, and (v₁, v₂, v₃) corresponds to a current strategy, wherein v₁ relates to a random aspect of the action-selection strategy, v₂ relates to an exploitation aspect of the action-selection strategy, and v₃ relates to a heuristic aspect of the action-selection strategy.

11. The method of claim 1, further comprising finishing the training when a budget is consumed or resources are unavailable.

12. A non-transitory storage medium having stored therein instructions that are executable by one or more hardware processors to perform operations comprising:
performing a preprocessing stage of training a reinforcement learning agent being trained to perform a task in a computing system to determine a reference strategy based on a performance quality of a heuristic; and
performing an online stage of training the reinforcement learning agent by dynamically adapting an action selection strategy for each training epoch.

13. The non-transitory storage medium of claim 12, wherein the performance quality is determined by comparing a generalization of an optimizer to a generality of the reinforcement learning agent, further comprising performing a predetermined number of training epochs to move toward the selection strategy, wherein the predetermined number of training epochs select actions like the heuristic.

14. The non-transitory storage medium of claim 12, further comprising adopting the reference strategy for a first step of the online stage.

15. The non-transitory storage medium of claim 14, further comprising performing an online training epoch and obtaining metrics.

16. The non-transitory storage medium of claim 15, wherein the metrics include:
a first metric including a comparative evaluation of the reinforcement learning agent and a heuristic;
a second metric including a processing time to complete the training epoch; and
a third metric including resource utilization.

17. The non-transitory storage medium of claim 16, further comprising determining a step size based on the second metric and the third metric, wherein the step size relates to an increment for a next exploitation aspect of a next action selection strategy used in a next training epoch and determining a next random aspect and a next heuristic aspect of the next training epoch.

18. The non-transitory storage medium of claim 17, further comprising changing the action strategy to a next action strategy based on the next exploitation aspect, the next random aspect, and the next heuristic aspect.

19. The non-transitory storage medium of claim 18, wherein the next action selection strategy (sₙₑₓₜ) is based on sₙₑₓₜ=(v₁−az, v₂−az, v₃+2az), wherein a is a variation, z is a generalization score, and (v₁, v₂, v₃) corresponds to a current strategy, wherein v₁ relates to a random aspect of the action-selection strategy, v₂ relates to an exploitation aspect of the action-selection strategy, and v₃ relates to a heuristic aspect of the action-selection strategy.

20. The non-transitory storage medium of claim 12, further comprising finishing the training when a budget is consumed or resources are unavailable.
